(19) United States
(12) Patent Application Publication
(10) Pub. No.: US 2004/0006498 A1
(43) Pub. Date: Jan. 8, 2004

(54) Administration apparatus for reservation of shared vehicle

(75) Inventors: Shunsuke Ohtake, Shiki-shi (JP); Koichi Ogura, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: HONDA GIKEN KOGYO KABUSHIKI KAISHA, Tokyo (JP)

(21) Appl. No.: 10/611,876

(22) Filed: Jul. 3, 2003

(30) Foreign Application Priority Data
Jul. 8, 2002 (JP) 2002-499323
Jul. 8, 2002 (JP) 2002-199325
Mar. 19, 2003 (JP) 2003-075388

(51) Int. Cl. G06F 17/60

(52) U.S. Cl. 705/5; 705/13

(57) ABSTRACT

An administration apparatus is provided for reservation of a shared vehicle that administrates usage reservations of shared vehicles for the convenience of users. A control unit 11 in a control room 1 accepts an application for reservation time applied for by a user 3 via a mobile phone terminal 4, and then, according to the division of the minimum time unit of the reservation setting time, confirms the available time from one unit before that including the present time, displays it, and confirms whether there is an empty vehicle in a departure port or not with reference to a port master 15 and a reservation master 17. Then, the control unit 11 determines whether the usage start unit input by the user 3 is a unit in the future relative to the present time, including a leading buffer time of the unit, or not. In the case where the usage start unit is a future unit relative to the present time including the leading buffer time, this executes normal usage reservation. Moreover in the case where the usage start unit is not a future unit relative to the present time including the leading buffer time, backdated reservation from one unit back is executed.

### BACKGROUND OF THE INVENTION

1. Field of the Invention

The present invention relates to an administration apparatus for reservation of a shared vehicle that, when a shared vehicle parked in a parking region is used by a plurality of users, administrates the reservations of the users of the shared vehicle.

2. Description of the Related Art

Heretofore, there are shared vehicle systems whereby a shared vehicle parked in a parking region called a port, for example, is rented to a user who has made a reservation.

In an administration apparatus for reservations used in this shared vehicle system, in general reservation setting times are divided into 30 minute or one hour unit periods for example, and a usage reservation is accepted using the earliest reservation setting time division after the current time as the reservation start time.

That is, if it is made possible to accept reservations backdated to the past, there is a possibility of causing a reservation to be unavailable due to input error. Therefore, in such a system, the construction is such that all reservations for already elapsed time in the past are identified as errors.

Furthermore, for example, some systems automatically determine that the reservation input is an input mistake, rather than setting that the input is an error. In such an apparatus, when a user inputs a date and time for which he or she wishes to make a reservation, if the input time is in the past, it is determined that the desired appointment time is at the same time on the day after the desired appointment time is input, and processing is performed (for example, refer to Japanese Unexamined Patent Application, First Publication No. 2002-279310).

However, in a reservation administration apparatus used for a conventional shared vehicle system, in the case where a large minimum time unit is set for the reservation setting time, such as one hour for example, usage reservations can only be made in one hour units (reservation start time may not be able to be set). Consequently, there is a problem of inconveniencing the user in that if he or she ever misses a reservation start time, the vehicle cannot be used until another hour has passed. Conversely, in the case where a small minimum time unit is set for the reservation setting time, such as one minute for example, the user must arrange his or her time in one minute units in order to make a reservation. Hence there is a problem that the reservation process becomes cumbersome. Therefore, there is a problem that however large or small the minimum reservation setting time unit is made, it causes inconvenience to the user.

### SUMMARY OF THE INVENTION

The present invention takes the above problems into consideration, with an object of providing an administration apparatus for reservation of a shared vehicle that administrates usage reservations of shared vehicles for the convenience of users.

In order to solve the above problems, an administration apparatus for reservation of a shared vehicle according to a first aspect of the invention is an administration apparatus for reservation of a shared vehicle that is used in a shared vehicle system in which a shared vehicle parked in a parking region is lent to a user who has made a usage reservation, comprising: a reservation confirmation device (for example step S3 of embodiments) which can confirm the reservation state of the shared vehicle backdated from the present time to the past; a vehicle availability detection device (for example step S4 of the embodiments) which detects whether there is a shared vehicle available that is not reserved for another user in the parking region where the user wishes to start his or her use; and a reservation administration device (for example, steps S5 to S16 in the embodiments) which, in the case where it is confirmed that there is a shared vehicle available in the parking region where the user wishes a reservation to use the shared vehicle, accepts the usage reservation using the time division in the past closest to the present time as a reservation start time, backdating the reservation start time to the past.

In an administration apparatus for reservation of a shared vehicle having the above construction, when a user makes a reservation to use a shared vehicle for example, in the case where there is adequate time from the present time to an available reservation start time, the available vehicle detection device checks reservation status information to detect whether there is a shared vehicle available or not in the parking region where the user wishes to start his or her use, backdated to the past by at least one minimum permissible reservation setting time unit, using the reservation confirmation device. Then, in the case where it is confirmed that there is a shared vehicle available in the parking region where the user wishes to make a usage reservation, the reservation administration device backdates the reservation start time to the past, and accepts the usage reservation using the time division in the past closest to the present time as a reservation start time, thus enabling the user to make a shared vehicle usage reservation at his or her own convenience.

An administration apparatus for reservation of a shared vehicle according to a second aspect of the invention is an administration apparatus for reservation of a shared vehicle according to the first aspect, wherein in the case where a prescribed time before the time division when usage is accepted to start is defined as a leading buffer time, when the user wishes to make a reservation to use the shared vehicle, in the case where the present time is inside the leading buffer time of the nearest future unit time division, the reservation administrating device processes the usage reservation as a normal usage reservation without backdating it to the past.

Using an administration apparatus for reservation of a shared vehicle having the above construction, when a user requests a usage reservation, in the case where the present time is inside the leading buffer time of the nearest future unit time division, it is possible for the user to avoid making a backdated usage reservation due to the leading buffer time, which does not require usage reservation, by making an ordinary usage reservation, being a usage reservation which is not backdated to the past.

An administration apparatus for reservation of a shared vehicle according to a third aspect of the invention is an administration apparatus for reservation of a shared vehicle that comprises a reservation administration device (for example steps S21 to S28, S31, and S35 to S36) which administers a user's reservation according to unit time divisions, and that is used in a shared vehicle system in which a shared vehicle parked in a parking region is lent to a user who has made a usage reservation, comprising: a reservation user determination device (for example, step S32 of the embodiments) which determines whether the user is an existing reservation holder who has already made a usage reservation of the shared vehicle or not; a reservation time confirmation device (for example, step S33 of the embodiment) which determines whether the present time is before the reservation start time of the existing reservation holder or not; and a vehicle usage availability determination device (for example, step S34 of the embodiment) which determines whether there is the shared vehicle available in the parking region, and in the case where there is the shared vehicle available before the reservation start time requested by the existing reservation holder, the reservation administration device permits (for example, steps S31 and S35 through S36) the existing reservation holder to use the shared vehicle before the reservation start time.

In an administration apparatus for reservation of a shared vehicle with the above construction, when an existing reservation holder of a shared vehicle goes to a parking region to use a shared vehicle, for example, in the case where there is adequate time before the reservation start time, if the user finds the shared vehicle in the parking region and wishes to use the shared vehicle, it is firstly determined whether the user is an existing reservation holder or not by the reservation user determination device. Then, the reservation time confirmation device confirms whether it is before the reservation start time of the existing reservation holder or not, and also the vehicle usage availability determination device confirms whether there is a shared vehicle available in the parking region or not. If the usage request is from the existing reservation holder, and there is a shared vehicle available before the reservation start time requested by the existing reservation holder, the reservation administration device permits the existing reservation holder to use the shared vehicle before the reservation start time, so that it is possible for the user to start to use the shared vehicle at his or her own convenience.

### BRIEF DESCRIPTION OF THE DRAWINGS

FIG. 1 is a block diagram showing a structure of an embodiment of the present invention.

FIG. 2 is a diagram showing a port for parking shared vehicles used in the embodiment.

FIG. 3 is a flow chart showing reservation acceptance processing of the embodiment.

FIG. 4 shows a reservation start unit and a reservation finish unit after backdated reservation processing in the embodiment.

FIG. 5 is a flow chart showing reservation processing in a second embodiment.

FIG. 6 is a diagram showing reservation start time and reservation finish time of an original reservation in the embodiment.

FIG. 7 is a flow chart showing reservation pull forward processing in the embodiment.

FIG. 8 is a diagram showing reservation start time and reservation finish time after reservation pull forward processing in the embodiment.

FIG. 9 is a diagram showing reservation start time and reservation finish time after reservation pull forward processing in the embodiment.

### DETAILED DESCRIPTION OF THE INVENTION

Hereunder is a description of embodiments of the present invention with reference to figures (first embodiment).

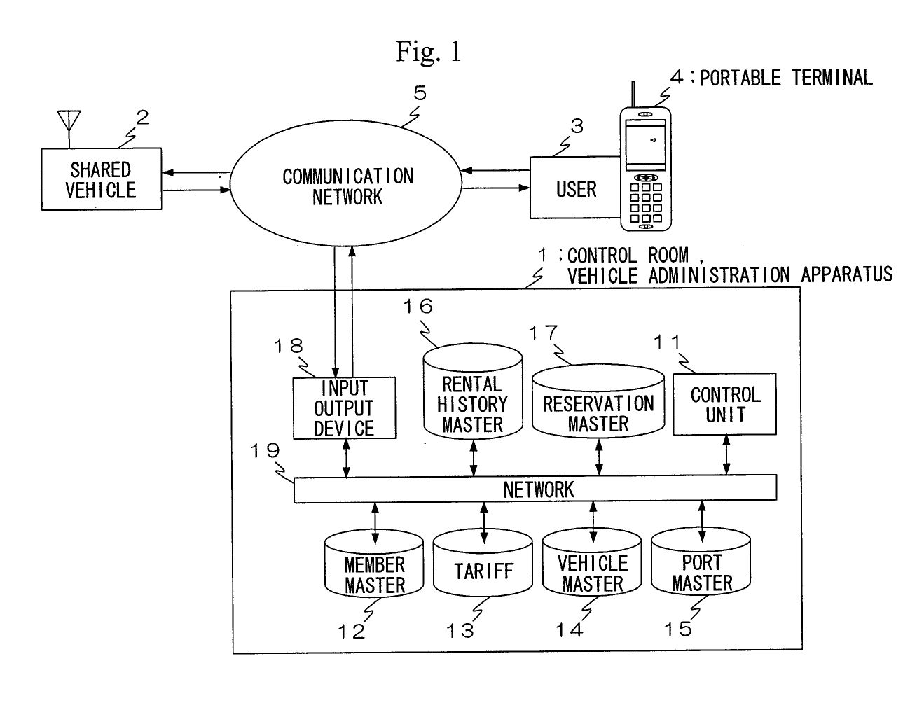

FIG. 1 is a block diagram showing a structure of a shared vehicle system containing an administration apparatus for reservation of a shared vehicle of a first embodiment of the present invention.

In FIG. 1, a control room 1 is an administration center of a shared vehicle system in which a vehicle administration apparatus is provided for administering vehicle sharing, such as the reservation and dispatching of shared vehicles 2 which are parked in a plurality of parking regions called ports and shared by users, and charging usage fees and the like. A shared vehicle 2 is used by a method called “reserve and ride” in which a user 3 registered as a member in the control room 1 inputs a reservation from a mobile phone terminal 4 to the control room 1, and enters information identifying a vehicle, such as departure and arrival ports, date, time, vehicle type and the like to secure the vehicle.

Furthermore, the shared vehicle 2 lent to the user 3 is parked in a parking space for one car, called a lot, in the parking region called a port, and the shared vehicle 2 is provided with a communication antenna and communication device for radio communication with the control room 1 to exchange a range of data. Moreover, the shared vehicle 2 is provided with a tag antenna and an ID tag reader, to identify the lot where it is parked in the port.

Furthermore, the shared vehicle 2 is provided with a display panel for displaying the usage status of the shared vehicle 2 such as “available”, “reserved”, “currently in use”, “not available”, “in maintenance” and the like, by a color coded display or alphanumeric display in a location that the user 3 can confirm from the outside of the shared vehicle 2.

Moreover, the mobile phone terminal 4 is a terminal having a connection function with a computer network or public line network such as the Internet and the like, which includes not only mobile phone terminals including mobile phone telephones and the personal handy phone system connected by wireless communication and mobile communication terminals, but also terminals connected by wired communication. Furthermore, a terminal using the above-escribed wired or wireless communication includes a terminal having a simple computer network connection function.

Moreover, the communication network 5 is a communication network for connecting the mobile phone terminal 4 held by the user 3 and the control room 1, and the shared vehicle 2 and the control room 1. It transmits and receives information, by wireless communication by WAP (Wireless Application Protocol) or the like, the Internet using the WWW (World Wide Web), or wired communication via a public line network such as a PSTN (Public Switch Telephone Network), ISDN (R) (Integrated Services Digital Network) and the like, for example.

The control room 1 administers one or more shared vehicles 2. In addition, there may be any number of users 3. Furthermore, the control room 1 administers a plurality of ports.

Moreover, the control room 1 comprises: a control unit 11, a member master 12; a tariff 13, a vehicle master 14, a port master 15, a rental history master 16, a reservation master 17, and an input output device 18.

The control unit 11 executes a vehicle administration control program in a computer system having a CPU (Central Processing Unit), and administers the operation of the whole of the control room 1.

The member master 12 is a data base which stores registered data of each user registered as a member, in which (1) user ID, (2) address, (3) authorization information, and the like, are stored for each member.

The tariff 13 is a data base in which a rate schedule for the usage of shared vehicles 2 is stored, and it stores (1) basic rate, (2) extended charge, (3) surcharge and discount charge, and the like.

The vehicle master 14 is a data base in which the status of each shared vehicle is stored in order to administer the shared vehicles 2, and it stores for example; (1) vehicle number, (2) vehicle information including vehicle type (type), equipment, color and the like, (3) parking location (parking port), (4) vehicle usage status, and the like.

The port master 15 is a data base in which the status of ports is stored in order to administer the shared vehicles 2, and it stores for example; (1) number of vehicles parked, (2) number of actual vehicles, (3) parked vehicle number, and the like.

The rental history master 16 is a data base in which a usage history of the shared vehicles 2 is stored, and it stores (1) user ID, (2) (rental) vehicle number, (3) rental time, (4) return time, (5) rental location, (6) return location, (7) distance traveled, (8) fuel consumed, and the like, for example, as individual information for each user.

The reservation master 17 is a data base in which reservation information is stored in order to administer vehicle reservation by the users 3 for “reserve and ride”, and it stores; (1) departure port, (2) arrival port, (3) information such as vehicle type, vehicle number and the like, (4) reservation start time, and (5) reservation finish time, associated with the user ID of the user 3.

The input and output device 18 is an interface section for the control room 1 to transmit and receive information associated with vehicle rental reservations to and from the mobile phone terminal 4, and for the control room 1 to transmit and receive information associated with the rental and return of vehicles, that is vehicle administration data, to and from the shared vehicles 2. Here, transmission and reception of vehicle administration data between the control room 1 and the shared vehicles 2 are performed directly by wireless communication.

The network 19 is a communication network comprising a LAN (Local Area Network) for data transmission and reception, which connects the control unit 11, the member master 12, the tariff 13, the vehicle master 14, the port master 15, the rental history master 16, the reservation master 17 and the input and output device 18, in the control room 1.

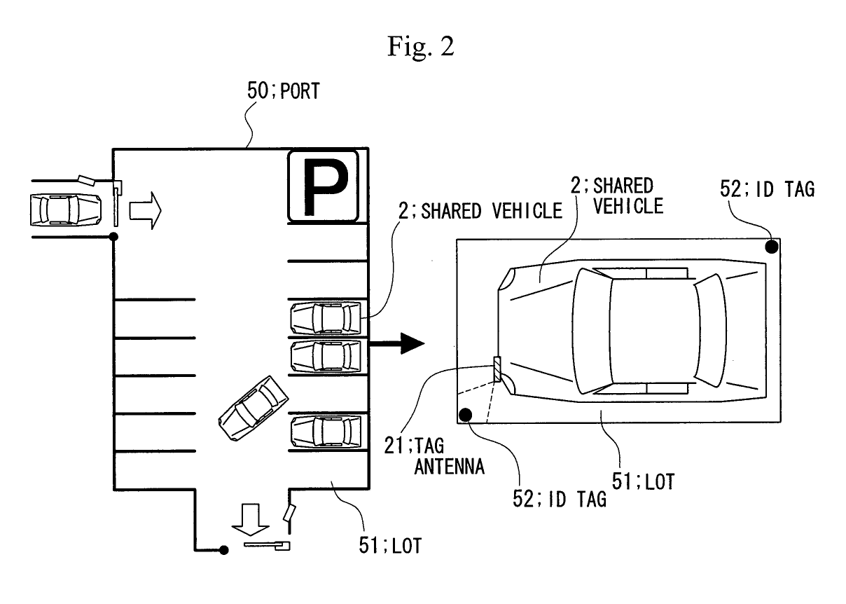

Next is a description of ports and tags using FIG. 2. Ports 50 are parking regions for parking the shared vehicles 2. The ports 50 in which the shared vehicles 2 are parked are placed in a range of locations so that the users 3 can move freely between the plurality of ports 50 at different geographical locations using the shared vehicles 2.

As shown in FIG. 2, a plurality of lots 51 for parking the shared vehicles 2 is provided in a port 50, and an ID tag 52, which transmits an ID number (lot ID) assigned individually to each of the ports 50 and the lots 51, is provided in each of the lots 51.

The ID tags 52 exchange ID numbers specific to each of the ports 50 and the lots 51 with the tag antennas 21 of the shared vehicles 2 using any one of an electromagnetic coupling method, an electromagnetic induction method, a microwave method, an electrostatic coupling method, an optical transmission method, and the like, and the shared vehicles 2 recognize the locations of the ports and the lots where they are parked by the ID tag readers reading the signals received by the tag antennas 21.

In addition, as shown in FIG. 2, the two ID tags 52 are placed diagonally in the lot 51, which correspond to the front end and the rear end of the shared vehicle, and the tag antenna 21 is placed in a front corner or a rear corner (front corner in the figure) close to the ID tag 52 of the shared vehicle 2.

Furthermore, the mechanism to capture the location of the port 50 and the lot 51 where the shared vehicle 2 is parked is not limited to the ID tag 52, but may also be a transmitter and receiver using an ETC (electronic toll collection system), or a position detection device using GPS (Global Positioning System).

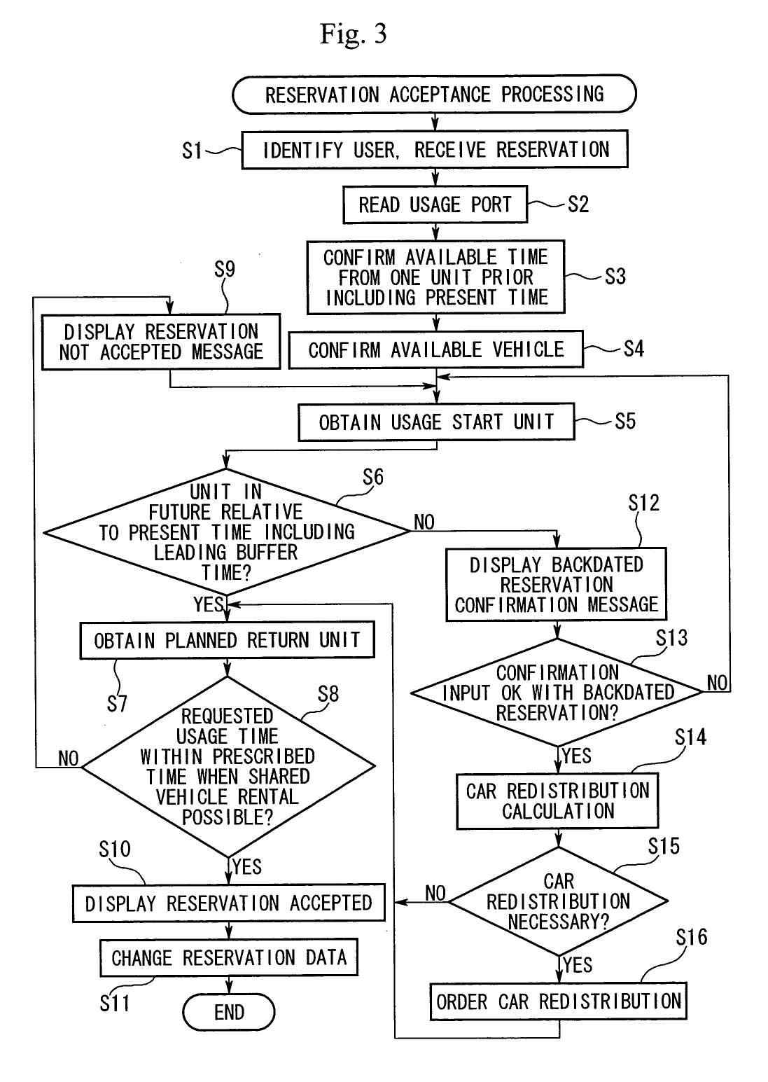

Next is a detailed description of reservation acceptance processing for renting a shared vehicle to a user in a shared vehicle system of the present embodiment, using the flow chart of FIG. 3.

Firstly, when a user 3 accesses the control room 1 via the communication network 5 using the mobile phone terminal 4, the control unit 11 in the control room 1 asks the user 3 for user identification via the mobile phone terminal 4, and prompts the user 3 to input reservation conditions for starting the reservation service (step S1). Here, reservation conditions means information for selecting a shared vehicle 2 to rent, such as departure port, arrival port, usage date, usage time, desired vehicle type and the like. In addition, vehicle type means a classification to distinguish a vehicle, such as vehicle type (type of car body), engine, transmission (for example, AT/MT), type of power transmission function such as two-wheel drive/four-wheel drive, existence of equipment such as sunroof and the like, color of car body, and the like.

Next, the control unit 11 reads information of the desired usage port from the input reservation conditions (step S2).

Then, according to the division of the minimum time unit (referred to hereunder as unit) of the reservation setting time when reservation is permissible, the control unit 11, confirms the available time from one unit before that including the present time, displays it (step S3), and confirms whether there is an empty vehicle in the departure port or not with reference to the port master 15 and the reservation master 17 (step S4).

Furthermore, based on the available time displayed, it prompts the user 3 to input the desired usage time in unit increments, and firstly the usage start unit input by the user 3 is obtained (step S5).

When the usage start unit input by the user 3 is obtained, the control unit 11 determines whether the usage start unit specified by the user 3 is a unit in the future relative to the present time, including the leading buffer time of the unit, or not (step S6). Here, leading buffer time means a prescribed time (for example, approximately 10 minutes) during which the shared vehicle 2 is permitted to be used before the unit time division, and the user 3 can take the shared vehicle 2 out from the port 50 at the unit time division by preparing for departure during this leading buffer time, such as loading the shared vehicle 2.

In step S6, in the case where the usage start unit specified by the user 3 is a future unit relative to the present time including the leading buffer time of the unit (YES in step S6), the control unit 11 obtains a planned return unit (step S7) input by the user 3 based on the available time displayed.

Then, it is determined (step S8) whether or not the usage time of the shared vehicle desired by the user 3, which is determined from the usage start unit and the planned return unit, is within the prescribed time when the shared vehicle 2 can be rented in the shared vehicle system.

In step S8, in the case where the desired usage time of the shared vehicle 2 by the user 3 is not within the prescribed time when the shared vehicle 2 can be rented (NO in step S8), the control unit 11 displays (step S9) an outside of service limit message displaying “reservation is not available at that time”, on the mobile phone terminal 4 held by the user 3 who has requested the reservation, control returns to step S5, and the above processing is repeated.

Furthermore, in step S8, in the case where the desired usage time of the shared vehicle 2 by the user 3 is within the prescribed time when the shared vehicle 2 can be rented (YES in step S8), the control unit 11 transmits a message “reservation OK” and the reserved vehicle number to the mobile phone terminal 4 held by the user 3 who has requested the reservation for display (step S10), then it stores (step S11) the usage start unit (reservation start unit) and planned return unit (reservation finish unit) and the aforementioned reservation conditions in the reservation master 17, associating the user ID of the user 3 who has requested the reservation and the vehicle number of the secured shared vehicle 2, and then the reservation acceptance processing operation is completed.

On the other hand, in step S6, in the case where the usage start unit specified by the user 3 is not a future unit relative to the present time including the leading buffer time of the unit (NO in step S6), the control unit 11 displays (step S112) a service display, “Backdate reservation? Usage reservation is from one unit back.” on the mobile phone terminal 4 held by the user 3 who wishes to make the reservation, and prompts the user 3 to input a confirmation (step S13).

In the confirmation input in step S13, in the case where the user 3 inputs “problem in backdated reservation from one unit back.” (NO in step S13), control returns to step S5, and the above processing is repeated.

Furthermore, in the confirmation input in step S13, in the case where the user 3 inputs “no problem in backdated reservation from one unit back.” (YES in step S13), a car redistribution calculation is carried out (step S14) to ensure that there is no shortage of shared vehicles 2 in the specified port 50, and it is determined whether car redistribution is necessary or not (step S15).

In step S15, in the case where car redistribution is necessary (YES in step S15), the control unit 11 orders (step S16) a shared vehicle to be moved (redistributed) to the specified port 50 by personnel attending the port 50, control proceeds to step S7, and the above processing is repeated. Moreover, in step S15, in the case where car redistribution is not necessary (NO in step S15), control proceeds to step S7 with no action, and the above processing is repeated.

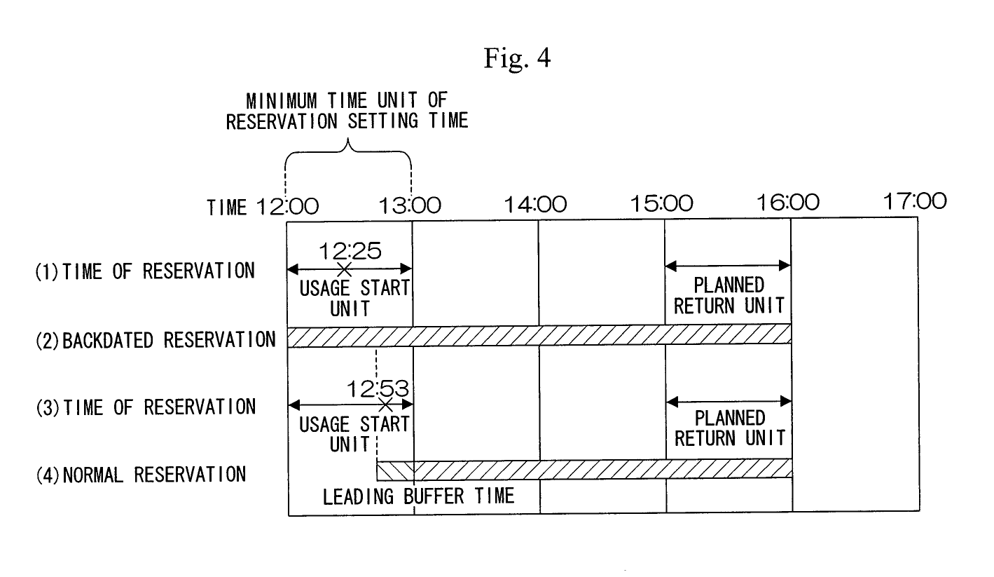

Next is a further detailed description of reservation acceptance processing in the shared vehicle system of the present embodiment described above, using a schematic diagram. As shown in FIG. 4 (1), in the case where the usage start unit for the reservation that the user 3 has requested is a unit from 12:00 to 13:00 for example, the planned return unit is a unit from 15:00 to 16:00 for example, the present time is 12:25, and the prescribed leading buffer time is 10 minutes, the control unit 11 accepts the reservation as a backdated reservation from one unit before the present time with the usage start unit being a unit from 12:00 to 13:00 as shown in FIG. 4 (2).

On the other hand, as shown in FIG. 4 (3), in the case where the usage start unit for the reservation wished by the user 3 is a unit from 12:00 to 13:00 for example, the planned return unit is a unit from 15:00 to 16:00 for example, the present time is 12:53, and the prescribed leading buffer time is 10 minutes, the control unit 11 does not accept the reservation with the unit from 12:00 to 13:00 as the usage start unit corresponding to a backdated reservation from one unit before the present time. Instead it makes a usage reservation as a reservation with the usage start unit being a unit from 13:00 to 14:00 as usual, and prompts the user 3 to prepare for departure of the shared vehicle 2 using 12:53 to 13:00 as the leading buffer time of the unit from 13:00 to 14:00 without charging for the usage.

In addition, in the present embodiment, the control unit 11 of the control room 1 comprises a reservation confirmation device, a vehicle availability detection device and a reservation administration device. To be more specific, step S3 of FIG. 3 corresponds to the reservation confirmation device, and step S4 of FIG. 3 corresponds to the availability detection device. Furthermore, steps S5 to S16 of FIG. 3 correspond to the reservation administration device.

As described above, according to an administration apparatus for reservation of a shared vehicle of the present embodiment, when a user 3 makes a reservation to use a shared vehicle 2 for example, in the case where there is adequate time from the present time to an available reservation start time, when the control unit 11 confirms through the reservation confirmation device and the vehicle availability detection device that there is a shared vehicle 2 available in the port 50 at which the user wishes to make a usage reservation, and confirms that there is a shared vehicle 2 available, the control unit 11 backdates the reservation start time to the past by the reservation administration device, and accepts the usage reservation using the time division in the past closest to the present time as the reservation start time, thus enabling a reservation to use a shared vehicle to be made at the user's convenience.

Accordingly, the user 3 can start usage of the share vehicle 2 at his or her own convenience, so that there is an effect of improving convenience. Furthermore, an operator of the shared vehicle system can use the shared vehicles 2 effectively, so that there is an effect in that the shared vehicle system can be operated efficiently.

Second Embodiment

Next is a description of a second embodiment of the present invention with reference to figures. The construction of a shared vehicle system including an administration apparatus for reservation of a shared vehicle of the second embodiment, and the operation and structure of ports for parking shared vehicles 2, are the same as the shared vehicle system and ports described in the first embodiment using FIG. 1 and FIG. 2, and hence the descriptions are omitted here. A reservation method for renting shared vehicles to users will be described in detail in the following description.

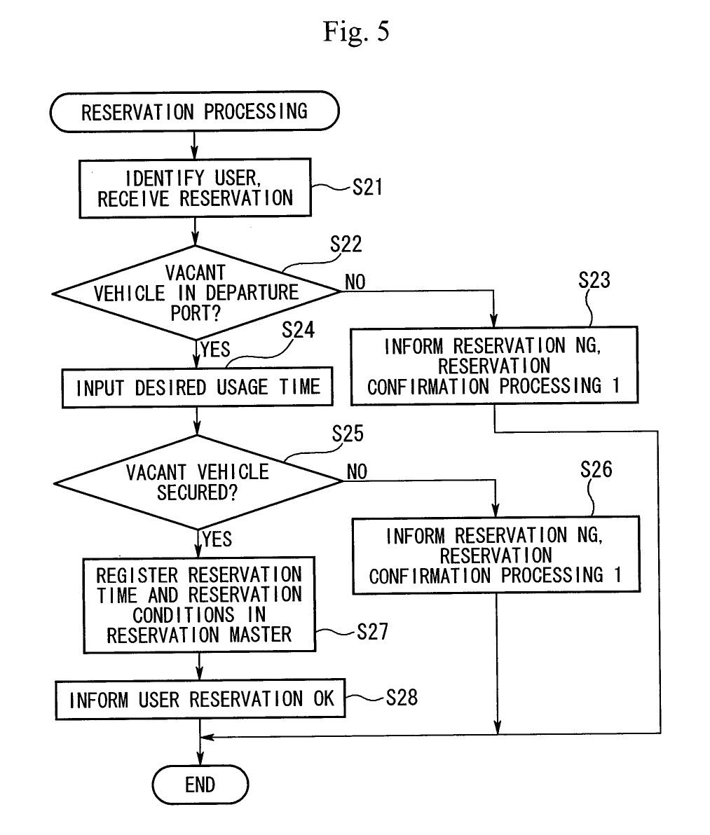

First is a detailed description of the reservation processing for renting a shared vehicle to a user in a shared vehicle system of the present embodiment, using the flow chart in FIG. 5.

Firstly, when a user 3 accesses the control room 1 via the communication network 5 using the mobile phone terminal 4, the control unit 11 in the control room 1 asks the user 3 for user identification via the mobile phone terminal 4, and prompts the user 3 to input reservation conditions in order to start the reservation process (step S21). Here, reservation conditions means information for selecting a shared vehicle 2 to rent, such as departure port, arrival port, usage day, usage time, desired vehicle type and the like. In addition, vehicle type means a classification to distinguish a vehicle, such as vehicle type (type of car body), engine, transmission (for example, AT/MT), type of power transmission function such as two-wheel drive/four-wheel drive, existence of equipment such as sunroof and the like, color of car body, and the like.

Next, the control unit 11 determines whether there is a vacant vehicle in the departure port or not by reference to the port master 15 and the reservation master 17 (step S22).

In step S22, in the case where there is no vacant vehicle in the departure port (NO in step S22), the control unit 11 sends the user 3 a message, “reservation NG” via the mobile phone terminal 4, proceeds to reservation confirmation processing 1, performs processing as requested by the user 3, such as waiting for a vacant vehicle, canceling the reservation, or the like, and finishes the reservation processing operation (step S23).

Furthermore, in step S22, in the case where there is a vacant vehicle in the departure port (YES in step S22), it prompts the user 3 to input the desired usage time (step S24).

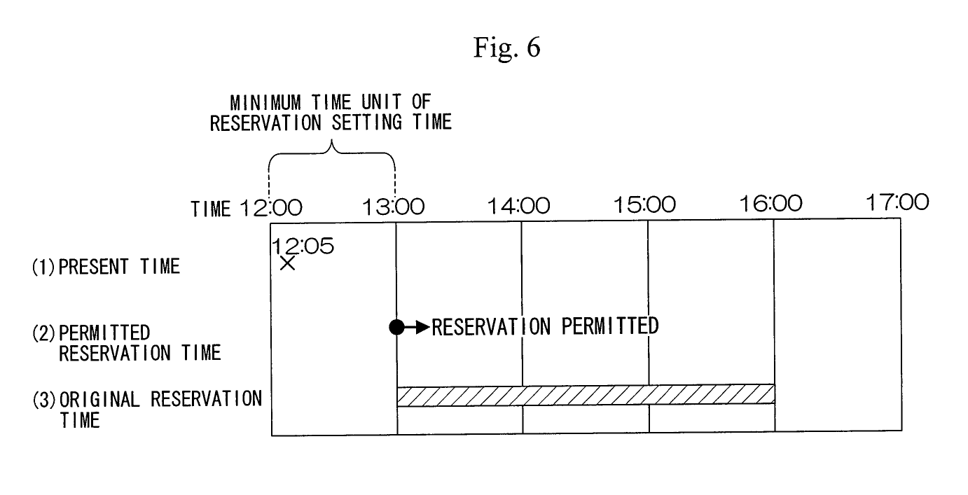

Here, for the reservation to use a shared vehicle 2, as shown in FIG. 6, if the present time is 12:05 (1), the reservation start time and reservation finish time are set at the minimum time unit, such as from 13:00 to 16:00 (3), or the like, for example, according to the minimum time unit division (one hour in the example in FIG. 6) of the reservation setting time when reservation is permissible (2).

Next, the control unit 11 determines whether it is possible to secure a vacant vehicle at the reservation start time and the reservation finish time input by the user 3 (step S25).

In step S25, in the case where it is not possible to secure a vacant vehicle at the reservation start time and the reservation finish time input by the user 3 (NO in step S25), the control unit 11 sends the user 3 a message “reservation NG” via the mobile phone terminal 4, proceeds to reservation confirmation processing 2, performs processing as requested by the user 3, such as waiting for a vacant vehicle, changing the reservation time, canceling the reservation, or the like, and finishes the reservation processing operation (step S26).

Furthermore, in step S25, in the case where a vacant vehicle can be secured at the reservation start time and the reservation finish time input by the user 3 (YES in step S25), the reservation start time, the reservation finish time, and the reservation conditions described above are stored in the reservation master 17, associating the user ID of the user 3 who has requested the reservation and the vehicle number of the secured shared vehicle 2 (step S27).

Moreover, a message, “reservation OK”, and the number of the reserved vehicle are transmitted to the mobile phone terminal 4 of the user 3 who has requested the reservation (step S28), and the reservation processing operation is finished.

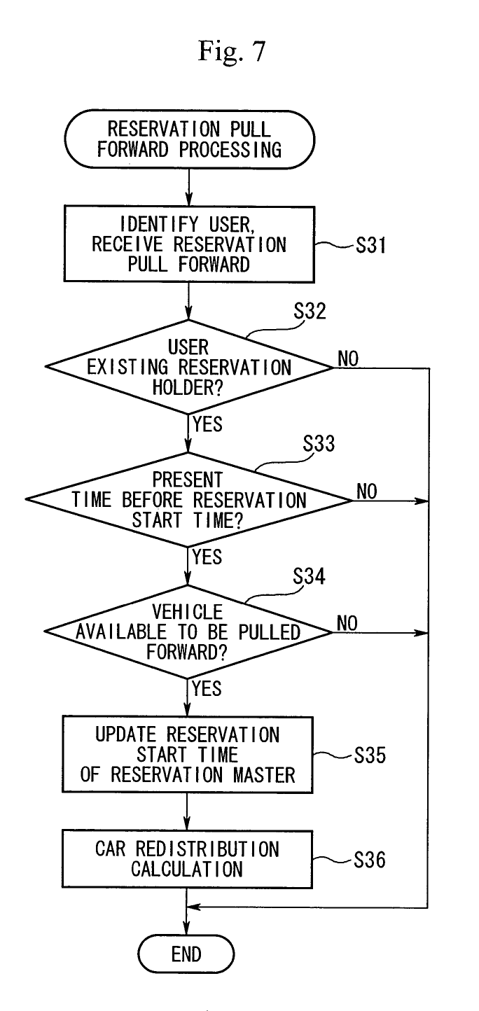

Next is a detailed description, using the flow chart of FIG. 7, of reservation pull forward processing for pulling forward a reservation to use a shared vehicle in a shared vehicle system of the present embodiment.

Assume, for example, that a user 3 sets out for a port 50 in order to rent a shared vehicle 2 for which a usage reservation has been made. At this time, it is assumed that the user 3 has arrived at the port 50 before the reservation start time input in the usage reservation, finds a shared vehicle 2 whose display panel displays “available” for example, and requests a pull forward change to the reservation start time.

At this time, firstly, in the control room 1, the control section 11 requests user identification from the user 3 via the mobile phone terminal 4, and accepts the change of reservation start time by the pull forward requested by the user 3 via the mobile phone terminal 4 (step S31), and determines whether the user 3 is an existing reservation holder or not with reference to the reservation master 17 (step S32).

In step S32, in the case where the user 3 is not an existing reservation holder (NO in step S32), the control unit 11 terminates the reservation pull forward processing.

Furthermore, in step S32, in the case where the user 3 is the existing reservation holder (YES in step S32), the control unit 11 determines whether the present time is before the reservation start time for which the user 3 made the reservation or not, with reference to the reservation master 17 (step S33).

In step S33, in the case where the present time is not before the reservation start time for which the user 3 made the reservation (NO in step S33), the control unit 11 terminates the reservation pull forward processing.

On the other hand, in step S33, in the case where the present time is before the reservation start time for which the user 3 made the reservation (YES in step S33), the control unit 11 determines whether there is a shared vehicle 2 that can be pulled forward or not, which is parked in the departure port for which the user 3 made the reservation, and also which is not used by another user 3, or which does not have a usage reservation by another user 3 (step S34).

Here, in step S34, in the case where there is no shared vehicle 2 available to be pulled forward (NO in step S34), the control unit 11 terminates the reservation pull forward processing.

Furthermore, in step S34, in the case where there is a shared vehicle 2 available to be pulled forward (YES in step S34), the control unit 11 assumes that the reservation is accepted from the time division one unit before the reservation start time when the user 3 first made a reservation by the minimum time unit of the reservation setting time, and changes the reservation start time of the user 3 that has been stored in the reservation master 17, associating the user ID of the user 3 who has requested the reservation, the vehicle number of the secured shared vehicle 2 and the reservation conditions, by overwriting it with a new reservation start time and updating (step S35).

Moreover, the control unit 11 updates the contents of the vehicle master 14 and the port master 15, stores that the user 3 has started to use the shared vehicle 2 from the new reservation start time in the rental history master 16, performs a car redistribution calculation for the shared vehicle 2 (step S36), and finishes the reservation pull forward processing for pulling forward the usage reservation.

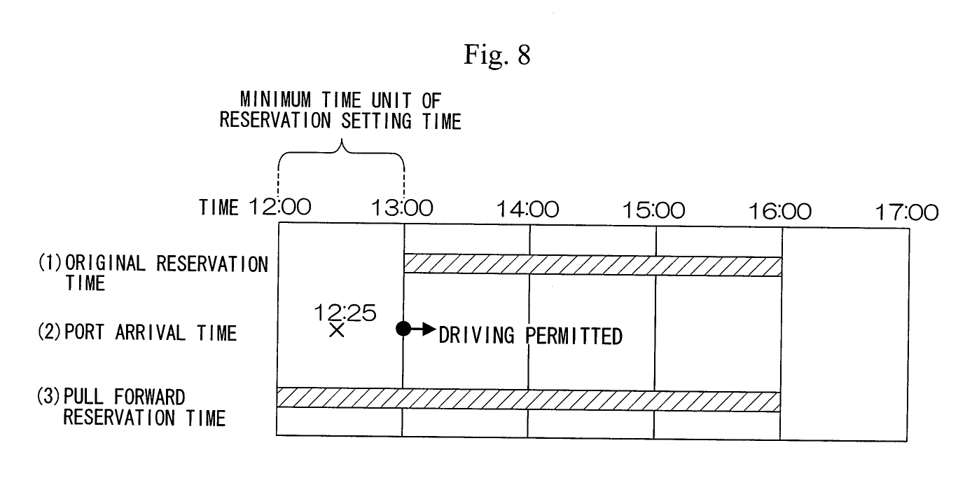

That is, as shown in FIG. 8, according to the minimum time unit division (one hour in the example in FIG. 8) of the reservation setting time when reservation is permissible firstly it is assumed that the user 3 has already made a reservation of a shared vehicle 2 from 13:00 to 16:00 (1), for example. At this time, if the time when the user 3 sets out for the port 50 in order to rent the shared vehicle 2 for which the user 3 has made the usage reservation is 12:25 (2), normally the user 3 would have to wait for 35 minutes in this port 50 to use the shared vehicle 2, otherwise he or she can't use it.

However, in the case where there is a shared vehicle 2 in this port 50 that can be pulled forward (3), if a change of the reservation start time by pulling it forward is requested, the control unit 11 in the control room 1 considers that the reservation and the usage start are from 12:00.

Furthermore, in the case where the user 3 wishes to start to use the vehicle from precisely the original reservation start time, he or she would want to arrive at the port 50 a little before the original reservation start time, and leave the port 50 precisely at the reservation start time.

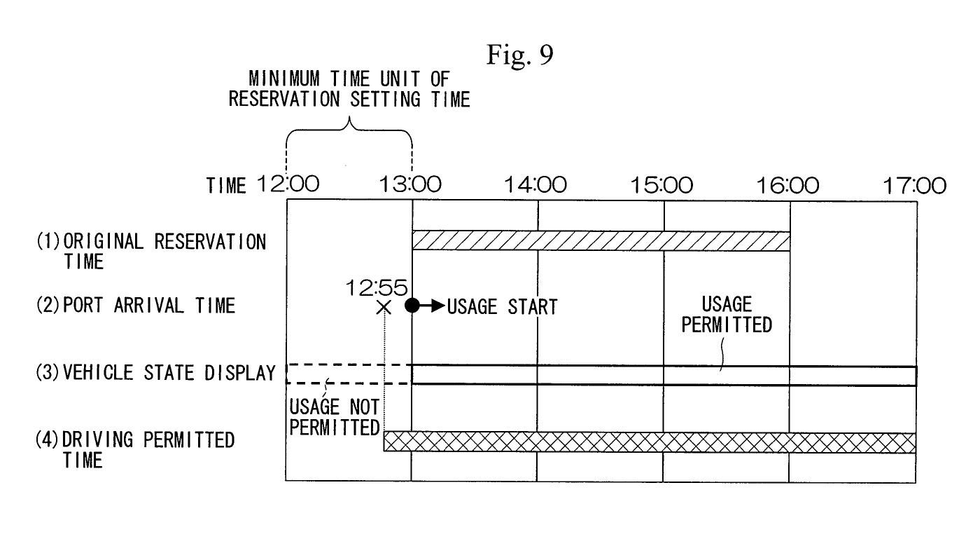

However, as shown in FIG. 9 for example, according to the minimum time unit division (one hour in the example in FIG. 9) of the reservation setting time when reservation is permissible, firstly, in the case where the user 3 has already made a reservation of a shared vehicle 2 from 13:00 to 16:00 (1), for example, if the time when the user 3 sets out for the port 50 in order to rent the shared vehicle 2 for which the user 3 has made the usage reservation is 12:55 (2), normally the user 3 has to wait for 5 minutes in this port 50 to use the shared vehicle 2, otherwise he or she can't use it.

Therefore, although the display panel of the shared vehicle 2 displays “not available” (3), a time may be set when the user 3 can get into the car if he or she wishes, by pulling the reservation start time forward (4). For example, if the time that can be used before the reservation start time while the display panel displays “not available” is 5 minutes, the user 3 can leave the port 50 at 13:00 to start to use the shared vehicle 2, as in the example in FIG. 9.

In addition, in the present embodiment, the control unit 11 in the control room 1 comprises a reservation administration device, a reservation user determination device, a reservation time confirmation device, and a vehicle availability determination device. To be specific, steps S21 to S28 in FIG. 5, steps S31 and S35 to S36 in FIG. 7 correspond to the reservation administration device, step S32 in FIG. 7 corresponds to the reservation user determination device, step S33 in FIG. 7 corresponds to the reservation time confirmation device, and step S34 in FIG. 7 corresponds to the vehicle availability determination device.

As described above, according to an administration apparatus for reservation of a shared vehicle of the present embodiment, in usage reservation of a shared vehicle 2, if a user 3 requests a change of reservation start time by pulling forward from the original reservation start time, in the case where this pull forward request is from the existing reservation holder, and there is a shared vehicle 2 available before the reservation start time at which the existing reservation holder requests its use in the port 50, the control unit 11 in the control room 1 permits the existing reservation holder to use the shared vehicle 2 before the reservation start time.

Furthermore, in the case where the user 3 arrives at the port 50 a little earlier than the original reservation start time, by setting a time when the user 3 can get into the car if he or she wishes, by pulling the reservation start time forward while displaying “not available” on the display panel of the shared vehicle 2, it is possible for the user 3 to leave the port 50 at precisely the reservation start time and start to use the shared vehicle 2.

Accordingly, it is possible for the user 3 to start to use the shared vehicle 2 at his or her own convenience, so that there is an effect of improving convenience.

As described above, according to the first aspect of an administration apparatus for reservation of a shared vehicle, when a user makes a reservation to use a shared vehicle for example, in the case where there is adequate time from the present time to an available reservation start time, if a reservation confirmation device and a vehicle availability detection device confirm that there is a shared vehicle available in the parking region where the user wishes to make a usage reservation, a reservation administration device backdates the reservation start time to the past, and accepts the usage reservation using the time division in the past closest to the present time as a reservation start time, thus enabling a shared vehicle usage reservation to be made at the user's convenience.

Accordingly, there are effects that user convenience is improved, shared vehicles are used effectively, and a shared vehicle system can be operated effectively.

According to the second aspect of an administration apparatus for reservation of a shared vehicle, when a user wishes to make a reservation to use a shared vehicle, in the case where the present time is inside the leading buffer time of the nearest future unit time division, the usage reservation is made as a normal usage reservation without backdating to the past, so that it is possible for the user to avoid making a backdated usage reservation due to the leading buffer time. Accordingly, it allows the user to avoid the expense of unnecessary usage reservation, and furthermore the reliability of a shared vehicle system is improved, so that there is an effect that a shared vehicle system and its usage can be spread widely.

According to the third aspect of an administration apparatus for reservation of a shared vehicle, in a reservation to use a shared vehicle, if an existing reservation holder requests a change of reservation start time by pulling forward from the original reservation start time, in the case where there is a shared vehicle available in the parking region before the reservation start time, it permits the existing reservation holder to use the shared vehicle before the reservation start time.

Accordingly, there are effects that user convenience is improved, shared vehicles are used effectively, and a shared vehicle system can be operated effectively.

What is claimed is:

1. An administration apparatus for reservation of a shared vehicle that is used in a shared vehicle system in which a shared vehicle parked in a parking region is lent to a user who has made a usage reservation, comprising:
a reservation confirmation device which can confirm the reservation state of said shared vehicle backdated from the present time to the past;
a vehicle availability detection device which detects whether there is a shared vehicle available that is not reserved for another user in said parking region where said user wishes to start his or her use; and
a reservation administration device which, in the case where it is confirmed that there is a shared vehicle available in said parking region where said user wishes a reservation to use said shared vehicle, accepts the usage reservation using the time division in the past closest to the present time as a reservation start time, backdating the reservation start time to the past.

2. An administration apparatus for reservation of a shared vehicle according to claim 1, wherein in the case where a prescribed time before said time division when usage is accepted to start is defined as a leading buffer time, when said user wishes to make a reservation to use said shared vehicle, in the case where the present time is inside said leading buffer time of said nearest future unit time division, said reservation administrating device processes said usage reservation as a normal usage reservation without backdating it to the past.

3. An administration apparatus for reservation of a shared vehicle that comprises a reservation administration device which administers a user's reservation according to unit time divisions, and that is used in a shared vehicle system in which a shared vehicle parked in a parking region is lent to a user who has made a usage reservation, comprising:
a reservation user determination device which determines whether said user is an existing reservation holder who has already made a usage reservation of said shared vehicle;
a reservation time confirmation device which determines whether the present time is before the reservation start time of said existing reservation holder or not; and
a vehicle usage availability determination device which determines whether there is said shared vehicle available in said parking region; and
in the case where there is said shared vehicle available before the reservation start time requested by the existing reservation holder, said reservation administration device permits the existing reservation holder to use said shared vehicle before the reservation start time.
